(19) United States
(12) Patent Application Publication
(10) Pub. No.: US 2004/0056635 A1
(43) Pub. Date: Mar. 25, 2004

(54) Non-polar charger

(76) Inventor: Chang I. Chang, Taipei (TW)

Correspondence Address: Chang I Chang, PO Box 82-144, TAIPEI, TW

(21) Appl. No.: 10/247,473

(22) Filed: Sep. 20, 2002

(51) Int. Cl. H02J 7/00

(52) U.S. Cl. 320/105

(57) ABSTRACT

Non-polar charger is disclosed. The input terminal of the charger supplies power source to a reference voltage circuit and a stabilizing voltage circuit. The stabilizing circuit stabilizes a voltage to the manual switching circuit and a positive inspection circuit. The positive inspection circuit and the negative inspection circuit determine the polarity of the voltage and is then indicated by an indication circuit. A positive and negative inspection circuit triggers and locks a self power cut-off circuit control to switching circuit so as to allow the charging of current supply of the positive and negative terminal clipping head. The front end of the sensing clip is provided with a conductive plate at one side and is connected to the circuit board with a conductive wire.

### BACKGROUND OF THE INVENTION

(a) Technical Field of the Invention

The present invention relates to a charger, and in particular, to a non-polar charger which supplies power source to a reference voltage circuit and a voltage stabilizing circuit.

(b) Description of the Prior Art

FIG. 1 shows a conventional power supply or charger device 4 restricted only to uni-polar loop and the device 4 cannot provide alternative application for the positive and negative clipping heads 40, 41. As a result, it is very common that the polarity of the heads 40, 41 are mistakenly connected, causing a short circuit to a battery 42 and damaging the conductive pole 43. In very serious case, the battery 42 may be exploded.

Further, there is no safety, power cut-off protection device, such as sensors, provided at the positive or negative clipping heads 40, 41 such that when the heads 40, 41 dislocate from the conductive pole 43, the power of the positive and negative pole cannot be cut-off.

Accordingly, it is an object of the present invention to provide a non-polar charger such that the two ends of the clipping head of the charging device can be alternatively charged.

### SUMMARY OF THE INVENTION

It is an object of the present invention to provide a non-polar charger having a voltage stabilizing circuit, a positive voltage inspection circuit, a negative voltage inspection circuit, a reference voltage circuit, a manual switching circuit, a main switching circuit, a switching circuit, a current conduction indication circuit and a self-locking self current cut-off circuit, characterized in that the input terminal of the charger supplies power source to the reference voltage circuit and the voltage stabilizing circuit, and a stable voltage is supplied to the manual switching circuit and the positive voltage inspection circuit, the positive voltage inspection circuit and the negative voltage inspection circuit determine whether the voltage is positive or negative and the polarity of the voltage is indicated by the indication circuit, when the value of the positive terminal is larger than the reference voltage the main switching circuit is in conduction caused by the initiation of the relay, the normal open point of the relay is connected to the normal close point of the delay so that the positive terminal outputs the voltage, the negative terminal sensing end receives a negative voltage and the value of the reference voltage is smaller than the negative voltage, the self cut-off circuit outputs is at a low potential the relay of the switching switch cannot be initiated and the normal close point is connected to the ground terminal and is connected to the control point, at this instance the output of the negative clipping head is a negative voltage, if the positive terminal sensing end receives a negative voltage, a voltage is output by the negative voltage circuit to the self cut-off relay circuit as a high potential such that the switching switch is simultaneously switched to conduct, and the normal open point is connected to the ground terminal and the control point is connected to the output of the positive terminal clipping head, and the relay is connected to the input end such that the positive terminal clipping head output is a negative voltage and the negative clipping head output is a positive voltage, thereby the charger provides the alternative use of the polarity.

Yet another object of the present invention is to provide a non-polar charger, wherein the switching circuit can be switched to mandatory conduct power to the positive clipping head to output a positive voltage by a manual switching circuit, achieving a supplying of power source.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional charger.

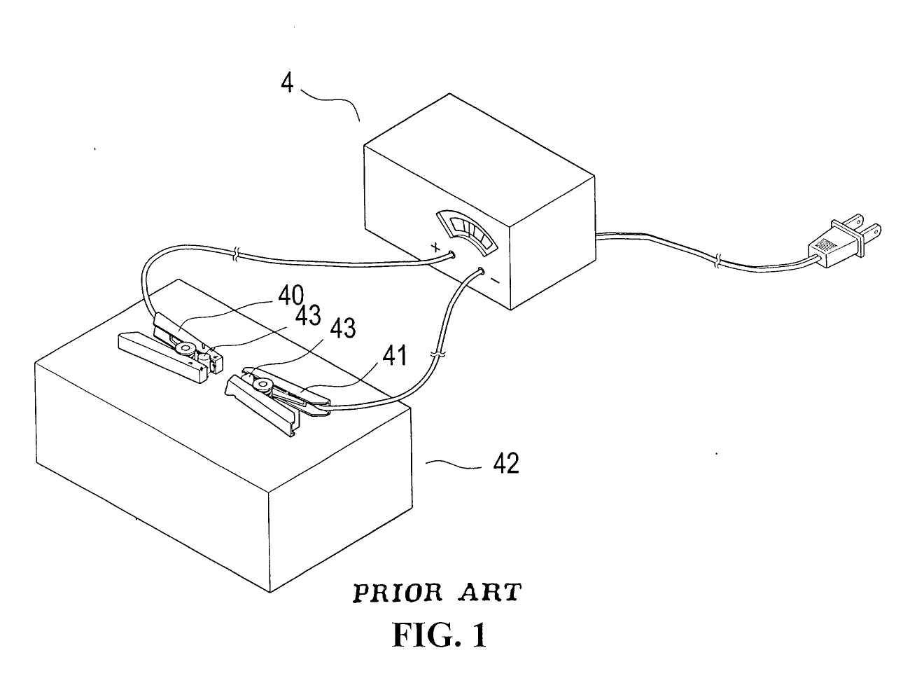

FIG. 2 is a perspective view of a charger of the present invention.

FIG. 3 is a block diagram flowchart in accordance with the present invention.

FIG. 4 is a circuit diagram in accordance with the present invention.

FIG. 5 is a perspective view of another preferred embodiment in accordance with the present invention.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

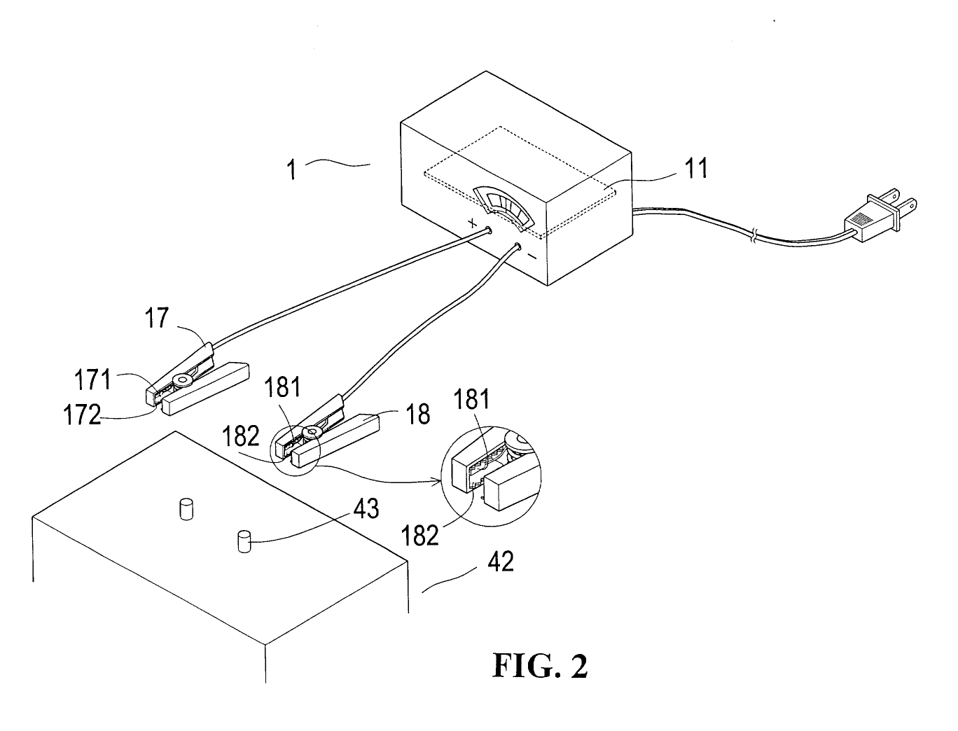

FIG. 2 shows a non-polar charger comprising a circuit board 11, a positive and negative terminal sensing clips 17, 18 and conductive plates 171, 181. The circuit board 11 is positioned within the charger 11 and the sensing clips 17, 18 are extended from the circuit board 11. The conductive regions 172, 182 at the front end of the clips are provided with the conductive plates 171, 181 at the side thereof for conduction to the circuit board 11. When the sensing clips 17, 18 are opened, the power source to the sensing clips 17, 18 are cut off and the positive and negative sensing clips 17, 18 do not have current and are safe to the user.

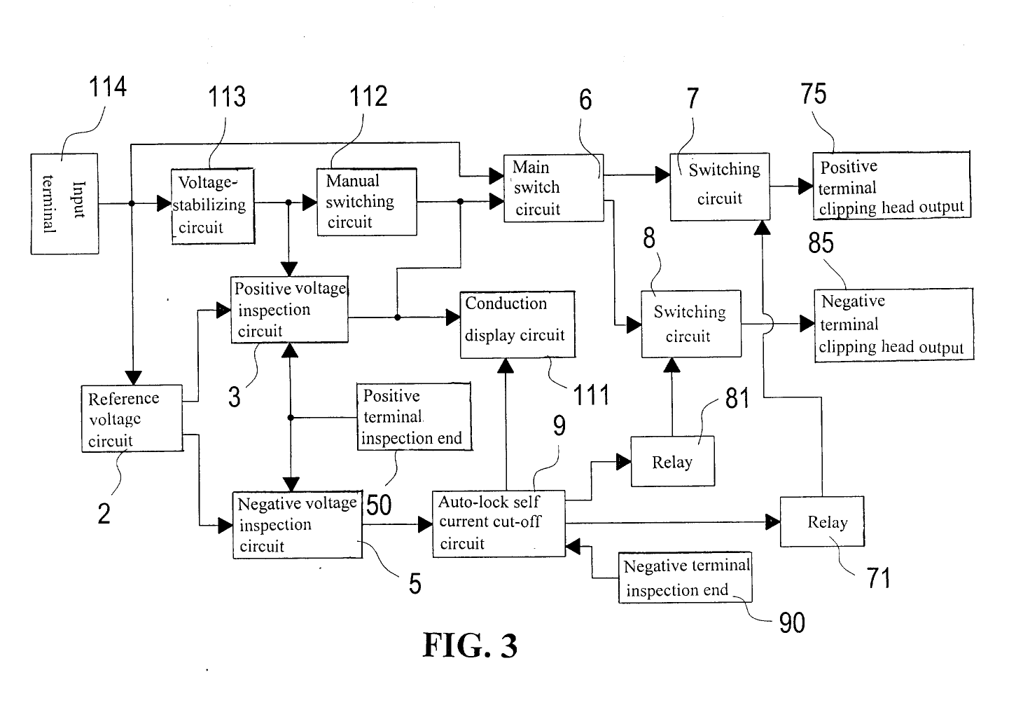

As shown in FIG. 3, power source is supplied to the reference voltage circuit 2 and the voltage stabilizing circuit 113 via the input end 114 and the stabilizing circuit 113 is used to stable supply voltage to a manual switching circuit 112 and the positive voltage inspection circuit 3. The inspection circuit 3 and the negative inspection circuit 5 are used to determine the positive voltage or negative voltage so as to ensure direction of the power supply to drive indication circuit 111, showing the presence of current. When the positive terminal inspection end 50 is larger than the reference voltage, the circuit 3 will trigger the relay 61 so that the main switching circuit 6 is in conduction. The normal open point 63 of the relay 61 is connected to the normal close point 72 of the relay 71 such that the positive terminal output 75 and the negative terminal inspection end go being a negative voltage, the value of the reference potential is smaller than the negative voltage so that the output of the self-power cut-off circuit 9 is at a low potential and the relay 81 of the switching switch 8 cannot be triggered. The normal close point 82 is connected to the ground terminal 70 and is connected to a control point 84. At this instance, the negative terminal clip output 85 is a negative voltage. On the other hand, if the positive terminal sensing end 50 receives a negative voltage, by means of a negative voltage circuit, a voltage is output to the output terminal of the self current cut-off circuit 9 being at high voltage such that the switching switches 8, 7 are simultaneously switched to conduction and the normal open point 73 is connected to the ground terminal 70 and the control point 74 is connected to the output 75 of the positive terminal. The relay 61 is not triggered and the normal close point 62 is connected to the input terminal 114. The output 75 of the positive clip is charge to negative voltage, and the output 85 of the negative clip head is a positive voltage so as to achieve the function of polar exchanging.

The two end points of the manual switching circuit 112 mandatory are caused to conduct such that the current of the stabilizing voltage circuit 113 passes the starting relay 61 via the control point 64 to the normal open point 63 connected to the positive clip head output 75 being a positive voltage. Then, a positive voltage source is supplied so as to avoid the battery 42 is at a low voltage or the voltage is lower than the sensed value, in order to start charging the manual switching circuit 112 so as to increase the activeness of application.

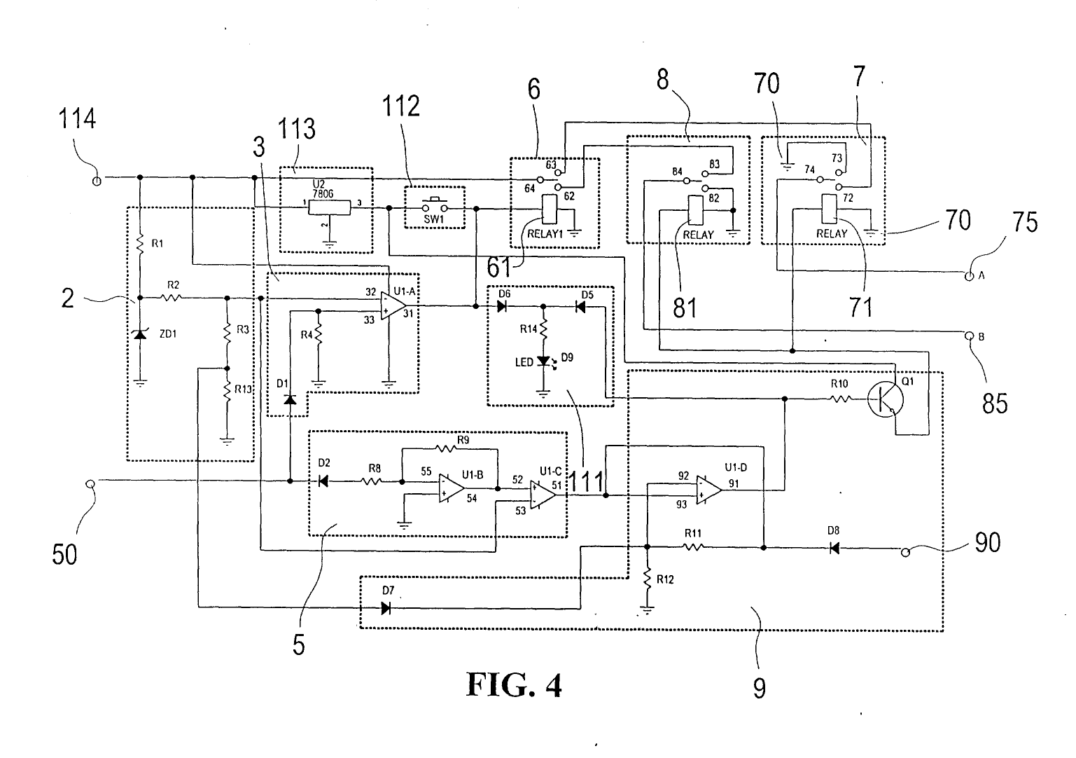

Referring to FIG. 4, if a DC voltage flows to resistors R1, R2, via the input terminal 114, and a reverse zener diode ZD1 is provided with a stable voltage, and the current of the resistance R2 respectively provides a reference voltage 2 output to the input point 32 of the calculation amplifier UIA and the input negative end 53 of the calculation amplifier UIC, such that when the positive terminal inspection end 50 receives a positive voltage, the diode ID1 is in conduction to the positive end 33 of the calculation amplifier UI-A such that the input point 32 and the positive end 33 produce a potential difference such that the output point 31 becomes a high potential to drive the current to pass through diode D6, resistance R14, causing the diode D7 to glow. At the same time the high potential of the amplifier UI-A initiates the normal open point 63 of the relay 61 pass through the normal close point 72 of the relay 71 to connect at the output end 75. When the negative terminal inspection end 50 receives a negative voltage, resistance R8 and diode D2 biased clockwise, and D1 biased anti-clockwise to the input point 33, such that the output point 31 of the calculation amplifier UI-A stops as a result of the low potential, and the input point 52 of the calculation amplifier UI-C is connected to the output point 54 of the calculation amplifier UI-B, and the input point 52 and the output point 54 are parallel connected to a resistance R9. By means of the diode D8 biased clockwise to the input point of the amplifier UI-D and is in conduction with the output point 51 of the amplifier UI-C, the negative end 92 and the input point 93 of the amplifier UI-D produce a potential difference.

The input point 91 is at a high voltage current, and passes through the diode D5, the resistance R14 of such that the diode D7 glows. When the output point 91 being at high potential passes through the resistance R10, the base terminal of the transistor Q1 is clockwise biased and at the same time, the starting relays 81, 71 are activated such that the normal close point 72 is switched to the normal open point 73 at the ground terminal 70. At this point, the output 75 of the positive terminal clip head is charged to a negative voltage, and when the normal close point 82 is switched to the normal open point at the normal close point 62, the negative terminal output 85 is charged to a positive voltage.

The voltage stabilizing circuit 113 stabilizes a voltage at the end point of the manual switch 112 connected to the output point such that the control point 64 is switched to normal open point 63, and via the normal close point 72 and the control point 74, the output 75 of the positive clipping head is a positive power source so as to overcome the no-voltage problem in the battery.

In accordance with the present invention, the circuit board 11 is mounted within the housing 19 and the front end of the housing 19 is extended to form conductive wires 151, 161 connected to the positive and negative terminal sensing clips 17, 18. One side of the housing 19 is provided with a plurality of diodes 191 to indicate whether the voltage is supplied with current. The rear end of the housing 19 is provided with securing seats 192, 193 having screws 194, 195 to be mounted therein.

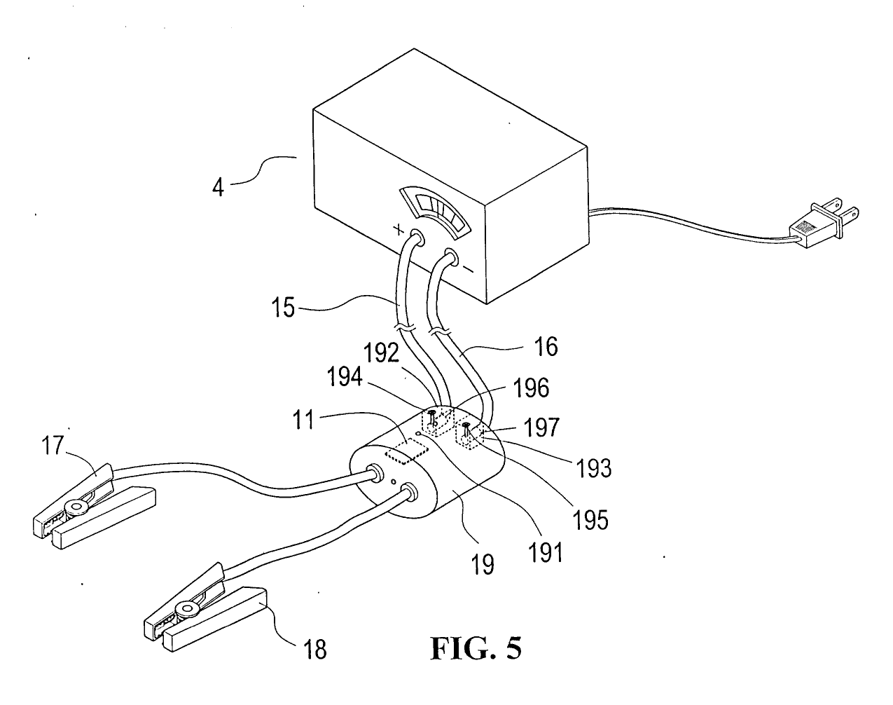

Holes 196, 197 are provided for the passage of wires 15, 16. When user uses a charger with polarity the wires 15, 16 at the front end of the charger 4 are cut and the wires 15, 16 are respectively inserted into the holes 196, 197 (as shown in FIG. 5) so as to achieve the non-polar objective of the present invention.

The advantages of the present invention are that

(i) The positive and negative wire clipping head can be used alternatively.

(ii) The power source of the positive and negative terminal clipping head is cut off when the positive and negative terminal clipping head are removed from the battery.

(iii) The charger is provided with a self polar-switching function.

(iv) When the voltage of the battery is approached to zero volt, the manual switching circuit can control the mandatory of current supply.

(v) The charger is provided with a current cut off protection device.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A non-polar charger having a voltage stabilizing circuit, a positive voltage inspection circuit, a negative voltage inspection circuit, a reference voltage circuit, a manual switching circuit, a main switching circuit, a switching circuit, a current conduction indication circuit and a self-locking self current cut-off circuit, characterized in that the input terminal of the charger supplies power source to the reference voltage circuit and the voltage stabilizing circuit, and a stable voltage is supplied to the manual switching circuit and the positive voltage inspection circuit, the positive voltage inspection circuit and the negative voltage inspection circuit determine whether the voltage is positive or negative and the polarity of the voltage is indicated by the indication circuit, when the value of the positive terminal is larger than the reference voltage the main switching circuit is in conduction caused by the initiation of the relay, the normal open point of the relay is connected to the normal close point of the delay so that the positive terminal outputs the voltage, the negative terminal sensing end receives a negative voltage and the value of the reference voltage is smaller than the negative voltage, the self cut-off circuit outputs is at a low potential the relay of the switching switch cannot be initiated and the normal close point is connected to the ground terminal and is connected to the control point, at this instance the output of the negative clipping head is a negative voltage, if the positive terminal sensing end receives a negative voltage, a voltage is output by the negative voltage circuit to the self cut-off relay circuit as a high potential such that the switching switch is simultaneously switched to conduct, and the normal open point is connected to the ground terminal and the control point is connected to the output of the positive terminal clipping head, and the relay is connected to the input end such that the positive terminal clipping head output is a negative voltage and the negative clipping head output is a positive voltage, thereby the charger provides the alternative use of the polarity.

2. The charger of claim 1, wherein the charger is further provided with a circuit board extended to form a positive and negative terminal sensing clip, and the front end of the clip is provided with a conductive plate at one lateral side thereof, and a conductive wire is connected to the circuit board.

3. The charger of claim 1, wherein the two end points of the manual switching circuit is mandatory in conduction such that the current via the stabilizing circuit passes through the starting relay via the control point being switched to the normal open point connected to the positive terminal clipping head output being a positive voltage and then supplies power source.

4. The charger of claim 1, wherein the voltage of the battery is supplied to the positive voltage inspection circuit and the negative voltage inspection circuit to determine the polarity of the voltage.

5. The charger of claim 1, wherein the indication circuit is a displaying device mounted with diodes, LCD display and bulbs.

6. The charger of claim 1, wherein the control element of the positive voltage inspection circuit and the negative voltage inspection circuit are provided with diodes, transistors, silicon-controlled rectifier, calculation amplifier and comparator.
